(19) United States
(12) Patent Application Publication
(10) Pub. No.: US 2007/0017749 A1
(43) Pub. Date: Jan. 25, 2007

(54) Elevator Installation with a Support Means End Connection and a Support Means, and a Method of Fastening an End of a Support Means in an Elevator Installation

(75) Inventors: Florian Dold, Reussbühl (CH); Adolf Bissig, Buochs (CH); Manfred Wirth, Rotkreuz (CH); Ernst Ach, Ebikon (CH); Claudio De Angelis, Münster (DE)

Correspondence Address: BUTZEL LONG, STONERIDGE WEST, 41000 WOODWARD AVENUE, BLOOMFIELD HILLS, MI, 48304, US

(73) Assignee: INVENTIO AG, Hergiswil NW (CH)

(21) Appl. No.: 11/459,138

(22) Filed: Jul. 21, 2006

(30) Foreign Application Priority Data
Jul. 22, 2005 (EP) 05106751.0

(51) Int. Cl. B66B 11/04

(52) U.S. Cl. 187/251

(57) ABSTRACT

In an elevator installation, an apparatus and a method use a support end connection for fastening a support device to an elevator car, a counterweight and/or a building. The support device has at least one cable or cable strand enclosed by a cable casing and is held in a wedge pocket by a wedge. The cable casing is formed of thermoplastic material or an elastomer and at least one of a region of the wedge or the wedge pocket is provided with a longitudinal wedge groove and a region of the wedge, of the wedge pocket or the cable casing has a reduced coefficient of friction. The support device is preferably a multiple cable.

### BACKGROUND OF THE INVENTION

The present invention relates to an elevator installation with a support means end connection and a support means and to a method of fastening an end of a support means in an elevator installation.

An elevator installation usually consists of a car and a counterweight, which are moved in opposite sense in an elevator shaft. The car and the counterweight are connected together and supported by way of support means. An end of the support means is fastened by a support means end connection to the car or to the counterweight or in the elevator shaft. The location of the fastening is oriented towards the mode of construction of the elevator installation. The support means end connection accordingly has to transmit the force, which acts in the support means, to the car or the counterweight or to the elevator shaft. It has to be designed in such a manner that it can transmit a required supporting force of the support means.

Currently, use is made of multiple support means in which several cables or cable strands are combined to form a support means. The support means consists of two cables or cable strands extending at a spacing from one another and consists of a common cable casing. The cables or cable strands then substantially serve for transmission of supporting and movement forces and the cable casing protects the cables or cable strands from external influences and it improves the transmission capability of drive forces which are introduced by drive motors into the support means.

In the case of known constructions the support means is fixed in a wedge pocket by means of a wedge. A first wedge pocket surface of the wedge pocket is, in this connection, formed in correspondence with a tension direction of the support means. This first wedge pocket surface is arranged in the departure direction of the support means. A second wedge pocket surface of the wedge pocket is formed to be displaced in correspondence with a wedge angle of the wedge relative to the first wedge pocket surface. The support means is now arranged between wedge pocket surfaces and wedge and draws the wedge into the wedge pocket by virtue of the friction conditions, whereby the support means is fixed. Obviously, a supporting run of the support means thus slides, during build-up of the supporting force, along the first wedge pocket surface, whereagainst a loose run of the support means experiences only a slight stretching movement in its position relative to the second wedge pocket surface. In the following description the first wedge pocket surface is termed a wedge pocket sliding surface and the second wedge pocket surface is termed a wedge pocket adhesion surface.

A support means end connection for a support means provided with an elastomeric sheathing is shown in patent application publication WO 00/40497, in which a wedge pocket angle is formed in such a manner that the pressure loading, which is produced by the wedge in the case of a given length and width, of the support means produces lower values than the permissible pressure loading of the elastomeric sheathing.

A disadvantage of this construction is that on the one hand the force introduction from the support means end connection to the cable casing of the support means is released solely by the geometry of the wedge, but that the transmission of force from the casing to the actual, supporting cable or cable strands is not released. The coefficients of friction within a cable strand or a cable are, in many cases, less than from the cable casing to the connecting parts. This has the consequence that a cable strand or cable is held only insufficiently within the cable casing, whereby the permissible supporting force of the support means is limited.

An object of the present invention is to provide an optimized support means end connection which maximizes the supporting force of the support means and securely transmits as well as fulfils the following points:
ensures the force introduction to the supporting cables or cable strands,
optimizes the overall stresses in the support means,
ensures a long service life of the support means,
is assembly-friendly and economic and,
in the case of need, also resists elevated ambient temperatures.

### SUMMARY OF THE INVENTION

The present invention relates to an elevator installation with a support means end connection and a support means and to a method of fastening a support means in an elevator installation.

The elevator installation consists of a car and a counterweight, which are moved in opposite sense in an elevator shaft. The car and the counterweight are connected together and supported by way of support means. The support means consists of at least one cable or a cable strand and a cable casing which surrounds the cable or the cable strand. The cables or cable strands are made of synthetic fibers or of metallic material, preferably steel wires. Several of these support means together form a support means strand.

An end of the support means is fastened by a support means end connection to the car or the counterweight or in the elevator shaft. The location of the fastening is oriented towards the mode of construction of the elevator installation. The support means is held in the support means end connection by means of a wedge which fixes the support means in a wedge pocket. The part of the support means end connection containing the wedge pocket is formed by a wedge housing. The support means has a loose run at its unloaded end. This loose run runs on a wedge pocket adhesion surface, which is inclined relative to the vertical direction, and is there pressed onto the wedge pocket adhesion surface by the wedge by means of its wedge adhesion surface. The support means is further led around a wedge curve and extends between an opposite wedge sliding surface and the wedge pocket sliding surface, which is oriented substantially vertically or in the tension direction of the support means, to the supporting run of the support means. The tensile force of the support means is thus transmitted by the pressing along the wedge surface and wedge pocket surface and the looping around of the wedge. The support means is held in the wedge pocket by means of the wedge and the support means extends between wedge and wedge pocket.

An acceptable tensile force of the support means is in that case decisively influenced by the design of the contacting surfaces in the form of the force flow from the support means end connection to the casing and the cables or the cable strands.

According to the present invention the cable casing substantially consists of thermoplastic plastics material or elastomer and a region of the wedge or a region of the wedge pocket is provided with a longitudinal wedge groove and/or a region of the wedge or the wedge pocket or of the cable casing is provided in the region of the support means end connection with measures reducing the coefficient of friction.

The longitudinal wedge groove is arranged substantially in a region of the wedge or the wedge pocket, which in the assembled state of the support means end connection stands in direct contact with the support means. The longitudinal wedge groove provided in the corresponding wedge region or in the wedge pocket region increases the normal force, which acts on the support means, in such a manner that the cable or the cable strand is pressed by the longitudinal wedge groove together with the cable casing and sliding of the cables or the cable strands within the cable casing is prevented. The size of the longitudinal wedge groove can in that case be formed in correspondence with the requirements. The shape of the longitudinal wedge groove follows substantially analogously to the design of wedge grooves of a drive pulley. In particular, a longitudinal wedge groove angle can be selected in conformity with the support means construction.

The use of measures, which reduce the coefficient of friction, in the region of the wedge or the wedge pocket or of the cable casing have the effect in the region of the support means end connection that a retightening or further sliding of the support means in the support means end connection can take place selectively. Measures reducing-the coefficient of friction can be slide means which are coated on regions of the wedge, the wedge pocket and/or the support means or can be coatings such as, for example, “Teflon” (a trademark of E. I. du Pont de Nemours and Company) coatings. In addition, production of the entire wedge from a material capable of sliding is possible.

Overall, the solutions according to the present invention make it possible that the introduction of force from the cable casing into the supporting cables or cable strands is ensured, the overall stress in the support means is optimized and a long service life of the support means can be guaranteed.

An advantageous embodiment proposes that a wedge adhesion surface or wedge pocket adhesion surface closer to the loose run of the support means is provided with a longitudinal wedge groove. This is particularly advantageous, since in the case of loading of the support means the pressing force, which arises through drawing-in of the wedge, of the wedge onto the wedge pocket increases to a particular extent the possible restraining force in the support means on the side of the wedge pocket adhesion surface and presses together the cable or the cable strand amongst one another and together with the cable casing, since this surface has longitudinal wedge grooves, whereby the maximum possible support means force is increased as a consequence of a deflection around the wedge curve. The force is in that case continuously increased, since the force increase on the side of the loose run is built up further. In addition, the wedge groove can be formed over the curve of the wedge.

In a further embodiment the wedge pocket adhesion surface and/or wedge adhesion surface disposed closer to the loose run of the support means is or are provided with a surface roughness increased relative to the rest of the surface of the wedge pocket or the wedge, or these surfaces are provided with transverse flutes or transverse grooves. This is an advantage, since in the case of loading of the support means the pressing force, which arises through drawing-in of the wedge, of the wedge on the wedge pocket increases to particular extent the possible supporting force in the support means on the side of the wedge pocket adhesion surface or wedge adhesion surface, since this surface has an increased roughness or has transverse flutes or transverse grooves, whereby the maximum possible support means force increases as a consequence of the deflection around the wedge. The force is in that case continuously increased, since the initial force on the side of the loose run is built up. The loose run of the support cable is securely held and a high supporting force can be transmitted. Moreover, the wedge pocket sliding surface on which the support means slides mainly during the loading process is formed with an appropriately lesser degree of roughness, which counteracts damage of the support means, since the surface thereof is not harmed. An economic support means end connection with a high load-bearing capability can be provided by means of this invention.

Alternatively or additionally thereto a wedge sliding surface and/or wedge pocket sliding surface disposed closer to the supporting run of the support means is or are provided with measures reducing the coefficient of friction. Measures reducing the coefficient of friction are, for example, a slip spray, an intermediate layer of synthetic material with sliding capability or a surface coating. This enables sliding of the support means during the loading process, which counteracts damage of the support means on the side of the support means end connection loaded in tension, since the surface thereof is not harmed and loading in the casing and in the cable or cable strand takes place uniformly. An economic support means end connection with a high load-bearing capability can be provided by means of this construction.

In another embodiment a wedge sliding surface or wedge pocket sliding surface disposed closer to the supporting run of the support means has a first and a second surface region, wherein the first surface region is arranged at the zone of departure of the support means from the support means end fastening and this first surface region has a greater wedge angle than the second surface region, which adjoins the first region and which forms the transition to a further surface region or to the upper end of the wedge pocket surface or the wedge surface. Advantageously, the transitions between the individual surface regions are formed to be continuous. In an optimized embodiment the surface regions are formed in such a manner that a transition from the first to the nth surface region extends continuously, i.e. in correspondence with a transition contour, wherein the nth surface region determines the main pressing region.

The solutions produce a progressive decrease in the pressing of the support means over a definable outlet path of the support means from the support means end connection. Advantageously, this surface region extends over less than 50% of the entire wedge sliding surface or wedge pocket sliding surface. The support means does not experience any abrupt transitions in loading. This increases the service life of the support system.

In addition, the ends, which are at the traction cable side, of the wedge sliding surface and the wedge pocket sliding surface are advantageously provided with radii or formed to be curved. The use of a radius or of curved transitions has the effect that pressing of the support means is built up gradually. No abrupt stress changes are imposed, and sliding of the support means in the highly loaded tension zone of the support means is made possible without damage of the support means. Alternatively, the wedge is constructed to be resilient at its wedge-shaped end. This leads to a slow reduction in the pressing force of the support means. In addition, the support means thereby does not experience any abrupt transitions in loading. This increases the service life of the support system.

In a further embodiment the wedge adhesion surface of the loose run is connected with the wedge sliding surface of the supporting run at the upper end of the wedge by means of the wedge curve and this wedge curve tangentially adjoins the wedge surfaces at the two sides, wherein in the embodiment according to the invention the radius of curvature of the curve is smaller towards the wedge adhesion surface of the loose run. A smaller radius of curvature produces a greater curvature of the support means and thereby indicates greater deformations in the support means itself. In countermove, the tension force acting in the support means simultaneously reduces towards the loose run in correspondence with the looping law of Eytelwein, which produces decreasing tensile stresses in the support means. Increasing deforming stresses are thus opposed by decreasing tensile stresses and in the ideal case compensate for one another. This produces an optimization of the overall stress in the support means and prolongs the service life of the support means overall.

In a further embodiment the wedge consists of a material soft by comparison with steel—a material with a low modulus of elasticity—preferably aluminium, synthetic material or a composite of metal and synthetic material. The use of a soft material produces an evening out of pressure points and correspondingly preserves the support means. In the case of use of a metal and synthetic material composite the possibility is additionally offered of realizing special sliding characteristics. With use of materials with a low modulus of elasticity the jump in stiffness between the wedge or the housing and the support means can be reduced, which results in an enhanced supporting force.

Additionally, the wedge pocket surface can be formed by means of an insert plate. Thus, a basic construction of a support means end connection can be provided, which depending on a construction of the support means can be completed by an appropriate insert plate or the insert plate can be formed, in accordance with requirements, with wedge grooves, transverse flutes, transverse grooves or to be sliding.

An advantageous support means end connection of the illustrated kind results in the case of use of a support means in the form of a multiple cable. The support means then consists of at least two cables or cable strands extending at a spacing from one another and the cable casing encloses the cable or cable strand composite and separates the individual cables or cable strands from one another. The support means in that case has a longitudinal structuring, preferably longitudinal grooves. The longitudinal structuring can be an image of an individual cable or cable strand, or a group of cables or cable strands can be fitted in a longitudinal structure. The cable casing can in that case be specially profiled according to the respective desired groove structure. An applicable construction of the wedge pocket or of the wedge is preferably oriented to the kind of longitudinal structuring. This enables provision of a particularly economic support means end connection. With particular advantage an end of the illustrated support means or of the multiple cable is divided up into the individual cable runs or cable strand runs and each cable run or cable strand run is clamped by means of a respectively associated longitudinal wedge groove of the wedge or of the wedge pocket. This allows a particularly good force introduction of the support means force into the support means end connection. The division of the support means into individual cable runs or individual cable strand runs can be carried out manually, for example by cutting or tearing, or it can be constrainedly effected by means of a center web which arises through formation of the longitudinal grooves on the wedge surface or wedge pocket surface.

In a preferred support means end connection the cable or the cable strand is glued, fused or mechanically connected with the cable casing in the region of the support means end connection. The gluing, fusing or mechanical connection of the cable or the cable strands with one another and with the cable casing has the effect that no relative movement within the support means can take place. A gluing is carried out, for example, in that a predefined quantity of liquid adhesive is dripped or cast at the end of the support means in the individual cables or cable strands. The adhesive draws in between cable or cable strand and casing, due to gravitational force and capillary action, and permanently connects these parts.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic elevation view of an elevator installation, with lower looping, with a support means end fastening according to the present invention fixed in the elevator shaft;

FIG. 2 is a schematic elevation view of an elevator installation, suspended directly, with the support means end fastening according to the present invention fastened to a car and a counterweight;

FIG. 3 is an enlarged view of the support end means fastening shown in FIG. 2 with a take-off force acting upwardly;

FIG. 4 is an enlarged view of the support means end fastening shown in FIG. 1 with a downwardly acting take-off force;

FIG. 5 is a cross-sectional view the support means shown in FIGS. 1-4 with spaced-apart cables;

FIG. 6 is a cross-sectional of an alternate support means with spaced-apart cable strands;

FIG. 7 is a cross-sectional view of the support means end connection shown in FIGS. 1-4;

FIG. 8 is a fragmentary cross-sectional view of the support means end fastening with longitudinal wedge grooves, which are arranged at the wedge, and the belt-shaped support means divided up into individual strands;

FIG. 8a a fragmentary cross-sectional view of the support means end fastening with longitudinal wedge grooves, which are arranged at the wedge pocket, and the belt-shaped support means divided up into individual strands;

FIG. 8c is a fragmentary cross-sectional view of the support means end fastening with longitudinal wedge grooves, which are arranged at the wedge pocket, and the belt-shaped support means with a fused casing;

FIG. 9 is a fragmentary cross-sectional view of the support means end fastening with longitudinal wedge grooves, which are arranged at the wedge, and the support means divided up into individual strands;

FIG. 9a is a fragmentary cross-sectional view of the support means end fastening with longitudinal wedge grooves, which are arranged at the wedge pocket, and the support means divided up into individual strands;

FIG. 10 is a fragmentary cross-sectional view of an alternate embodiment support means end connection with several wedge sliding surface regions and a mechanically connected support means end;

FIG. 11 is a view similar to FIG. 10 of another alternate embodiment support means end connection with insert plate; and

FIG. 12 is a cross-sectional view of a wedge for the support means end connection, with resiliently constructed tapering and coated surface as well as variable radius at the wedge curve.

### DESCRIPTION OF THE PREFERRED EMBODIMENT

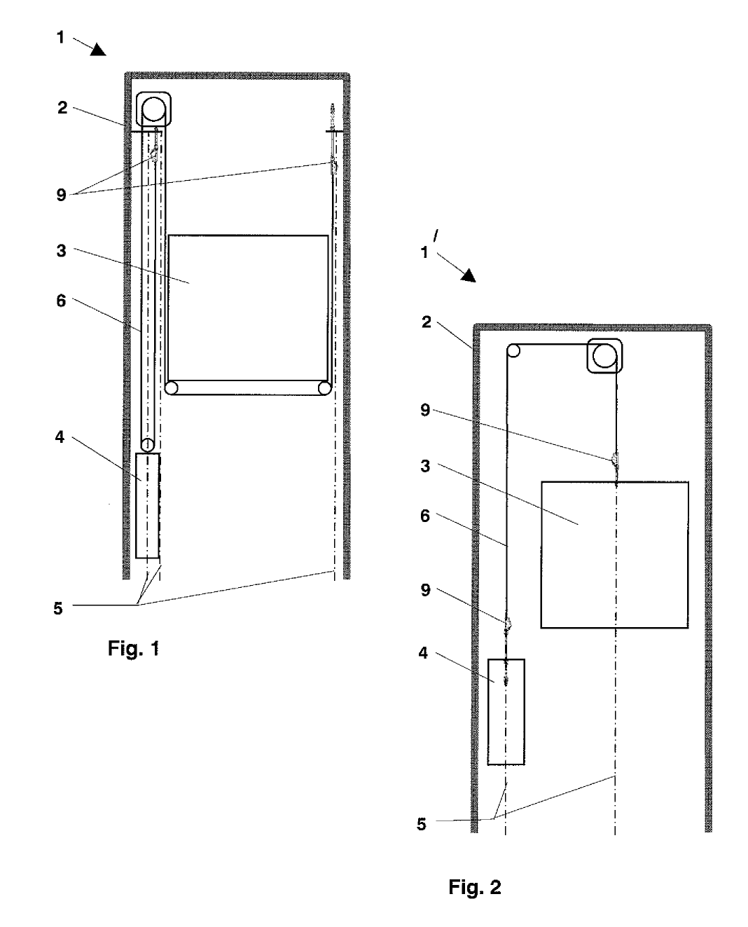

An elevator installation consists, as illustrated in FIGS. 1 and 2, of a car 3 and a counterweight 4, which are moved in opposite sense in an elevator shaft 2. The car 3 and the counterweight 4 are connected together and supported by way of a support means or device 6. An end of the support means 6 is fastened by a support means end connection 9 to the car 3 or the counterweight 4, according to FIG. 2, or in the elevator shaft 2, according to FIG. 1. The location of the fastening is oriented towards the mode of construction of the elevator installation. FIG. 1 shows this connection for an elevator installation 1 suspended 2:1 and FIG. 2 shows this connection for an elevator installation 1′ suspended 1:1. Axes 5 represent the direction of the loads imposed on the connections 9 by the car 3 and the counterweight 4.

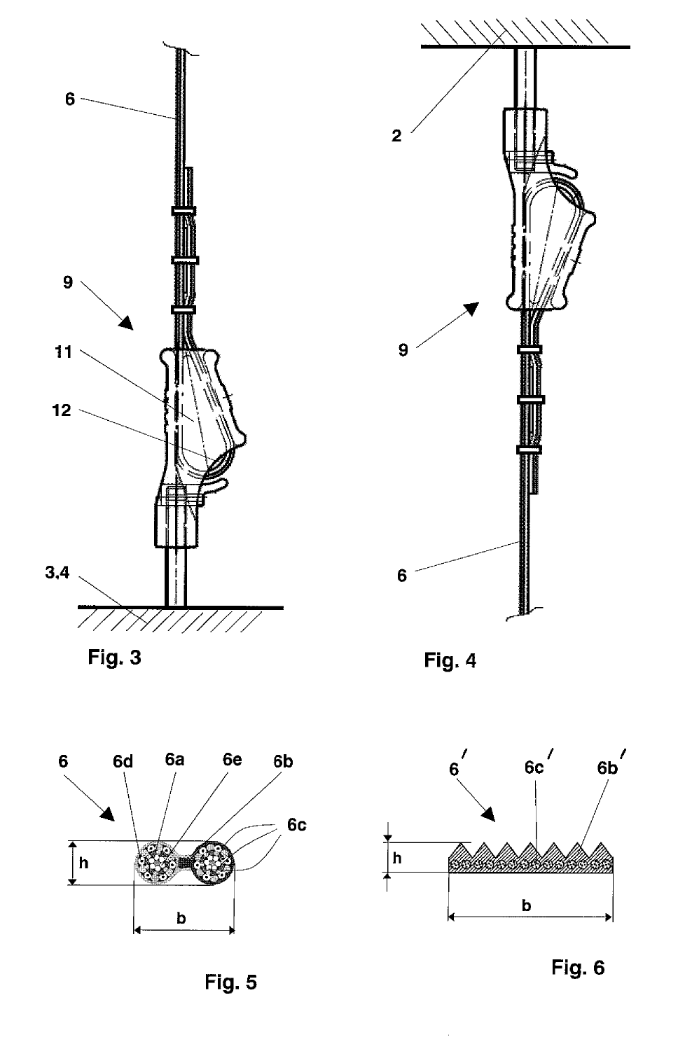

In FIGS. 3 and 4 it is apparent how the support means 6 is held in the support means end connection 9 by means of a wedge 12, which fixes the support means in a wedge pocket 11. The support means end fastening 9 can be mounted in various installation positions. In FIG. 3 the take-off direction is directed upwardly. In FIG. 4 the take-off direction is directed downwardly, as is usually used in the case of an elevator installation with looped-around suspension according to FIG. 1.

FIG. 5 shows the support means 6 in the form of a “twin rope”. In this connection, individual strands 6c, which in the illustrated example are made of synthetic fibers, are stranded to form a multi-layer cable 6a. The cable 6a is enclosed by a thermoplastic or an elastomeric cable casing 6b. An outer cable strand collar 6d in this connection is flush with and connected over an area with the casing 6b. In order to obtain a flexible cable the inner cable strand collar 6c is connected merely by the stranding process. In the illustrated example, two cables 6a of that kind are arranged at a spacing from one another and comprise the common thermoplastic or elastomeric cable casing 6b.

FIG. 6 shows an alternate embodiment support means 6′ in the form of a wedge-ribbed belt in which several cable strands 6c′ are surrounded by a thermoplastic or an elastomeric casing 6b′, wherein the wedge ribs form the profiling required for generating a drive capability. In each instance a double run of the cable strands 6c′ is associated in the illustrated example with one rib.

The cable 6a and the cable strand 6a′ run are one of glued, fused or mechanically connected with the cable casing 6b, 6b′ , respectively, in the region of the support means end connection 9.

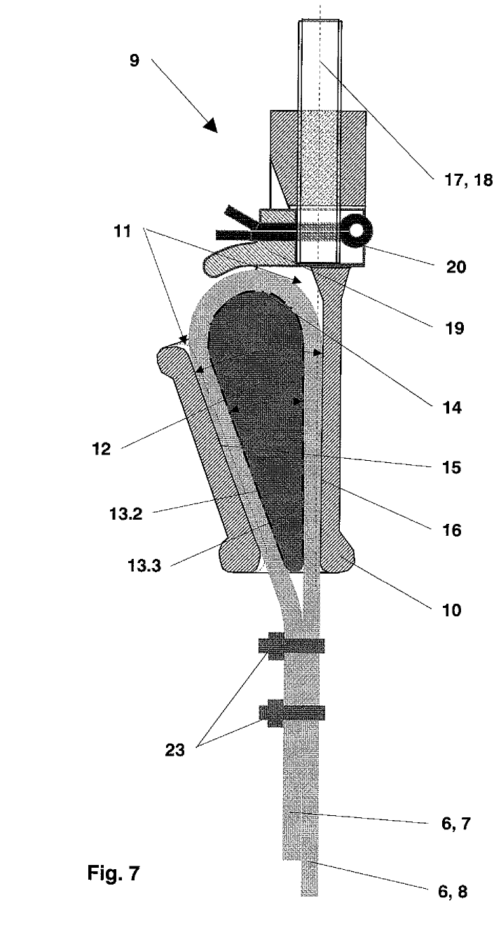

FIG. 7 shows the basic construction of the support means end connection 9. An end of the support means 6 (or 6′) is fastened by the support means end connection 9 to the car or counterweight or in the elevator shaft. The support means 6 is held in the support means end connection 9 by means of the wedge 12 which fixes the support means 6 in the wedge pocket 11. The part of the support means end connection 9 containing the wedge pocket 11 is formed by a wedge housing 10. The support means 6 has a loose run 7 at its unloaded end. This loose run 7 runs onto a wedge pocket adhesion surface 15 inclined relative to the vertical direction and is pressed there onto the wedge pocket adhesion surface 15 by the wedge 12 by means of an adhesion surface 13.2. The support means 6 is further led around a wedge curve 14 and runs between an opposite wedge sliding surface 13.3 and wedge pocket sliding surface 16, which is advantageously oriented vertically or in the tension direction of the support means 6, to a supporting run 8 of the support means 6. The tensile force of the support means 6 is thus applied by the pressing along the wedge and wedge pocket surfaces 13.2, 13.3, 15, 16 and the looping around of the wedge curve 14. The support means 6 is held in the wedge pocket 11 by means of the wedge 12 and the support means 6 runs between the wedge 12 and the wedge pocket 11.

A tolerable tensile force of the support means is in that case decisively influenced by the design of the contacting surfaces in the form of force flow from the support means end connection 9 to the casing of the cable 6 or of the cable strands.

In the illustrated example the wedge 12 is connected with an attachment point by means of a tie rod 17, 18. Moreover, the wedge 12 is secured, against slipping out, by way of means 19 securing against loss and a split-pin 20 and the loose run 7 is fixed to the supporting run 8 by means of plastic ties 23.

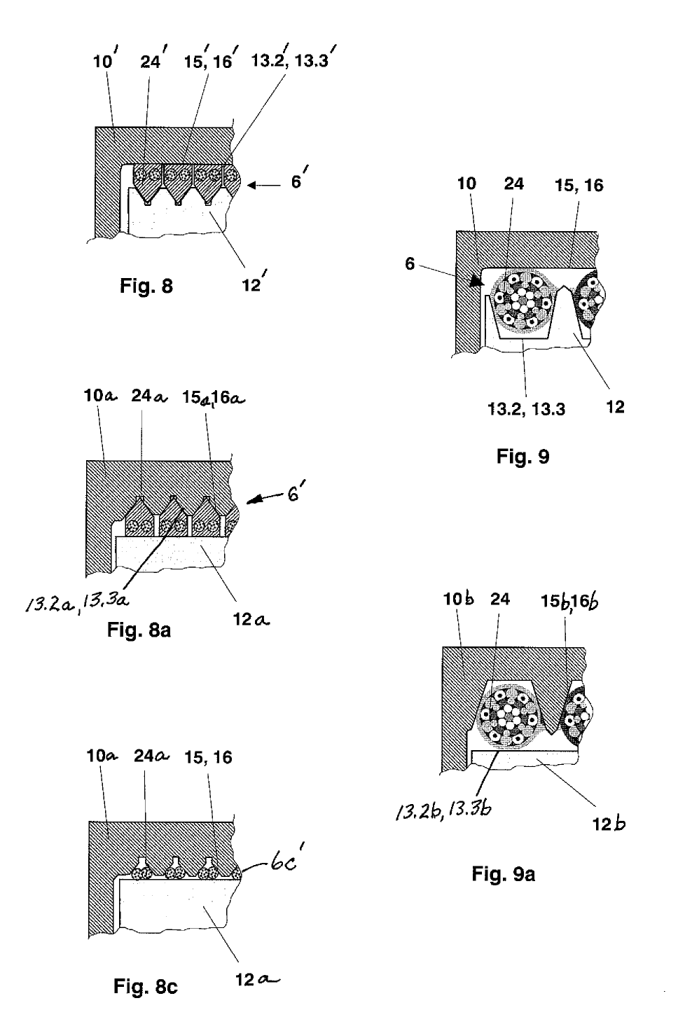

FIGS. 8, 8a, 8c, 9 and 9a show advantageous alternative embodiments of the wedge pocket surface and the wedge surface.

In FIG. 8 the wedge pocket surface 15′, 16′ of the housing 10′ is formed to be substantially smooth and the wedge surface 13.2′, 13.3′ is provided with longitudinal wedge grooves. The longitudinal wedge grooves are formed in correspondence with a profiling of the support means 6′. The support means 6′ is divided up in the region of the longitudinal wedge grooves of the wedge 12′ into individual support means runs 24′. In the illustrated example, in each instance two of the cable strands 6c′ are associated with a respective one of the support means runs 24′. The support means 6′ is effectively pressed by the groove pressing and a holding force can thereby be transmitted to the cable strands by way of the casing of the support means.

FIG. 8a shows a similar solution in which, however, the wedge pocket surface 15a, 16a of the housing 10a is provided with longitudinal wedge grooves and the wedge surface 13.2a, 13.3a is formed to be substantially smooth. The longitudinal wedge groove is advantageously arranged at the wedge pocket adhesion surface 15a. An optimum adhesion of the support means in the case of the loose run 7 of the support means 6′ thereby results. With particular advantage, in the case of this solution, as illustrated in FIG. 8c, it has proved that cable strands 6c′ of the support means 6′ can be clamped even when the cable casing 6b′ melts due to, for example, the action of fire.

In FIG. 9 the wedge pocket surface 15, 16 of the housing 10 is formed to be substantially smooth and the wedge surface 13.2, 13.3 is provided with longitudinal wedge grooves. The longitudinal wedge grooves are formed similarly to the wedge groove of a traction pulley. The support means 6 is divided up in the region of the longitudinal wedge grooves of the wedge 12 into individual support means runs 24. In the illustrated example a respective one of the cables 6a is associated with each individual support means strand 24. The support means 6 is effectively pressed by the groove pressing and a holding force can thereby be transmitted to the cable strands by way of the casing of the support means.

FIG. 9a shows a similar solution in which, however, the wedge pocket surface 15b, 16b of the housing 1Ob is provided with longitudinal wedge grooves and the wedge surface 13.2b, 13.3b is formed to be substantially smooth. The longitudinal wedge groove is advantageously arranged at the wedge pocket surface 15b. An optimum adhesion of the support means in the case of the loose run 7 of the support means 6 thereby results.

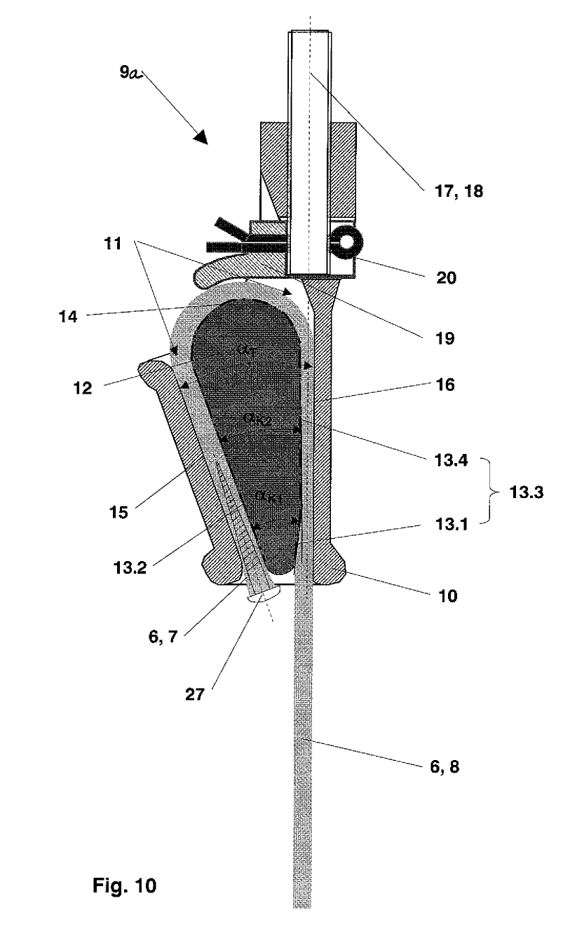

FIG. 10 shows another example of a constructed support means end connection 9a. The support means 6 is divided up at its end, as shown in FIG. 9, into individual support means runs 24. The cable is mechanically connected at its end, or at the end of the loose run 7, with use of a screw 27, for example a wood screw, with the cable casing. On tightening of the screw 27 in the end of the support means run 24 a crushing of the end fibers of the cable is effected. The pressing force exerted by the wedge 12 is thereby increased and the force transmission from the cable core to the casing is increased. Moreover, the screw head prevents tearing out of the support means in that it protrudes at the wedge 12 or at the housing 10. This additionally increases the maximum accessible tensile force in the support means.

The wedge 12 used in FIG. 10 has, additionally to the wedge sliding surface closer to the supporting run 8 of the support means 6, a first surface region 13.1 and a second surface region 13.4, wherein the first surface region 13.1 is arranged at the zone of departure of the support means 6 from the support means end fastening 9a and this first surface region 13.1 has a greater wedge angle αₖ₁ than a wedge angle αₖ₂ of the second surface region 13.4, which adjoins the first surface region 13.1 and which, in this example, forms the upper edge of the wedge surface. Many designs of this wedge shape are obviously possible. Several or many part surface regions can be arranged adjacent to one another or indefinitely small surface regions can be used, whereby a continuous curve results. In addition, the illustrated support means end connection has the means 19 securing against loss, which secures the wedge 12 in the wedge pocket 11.

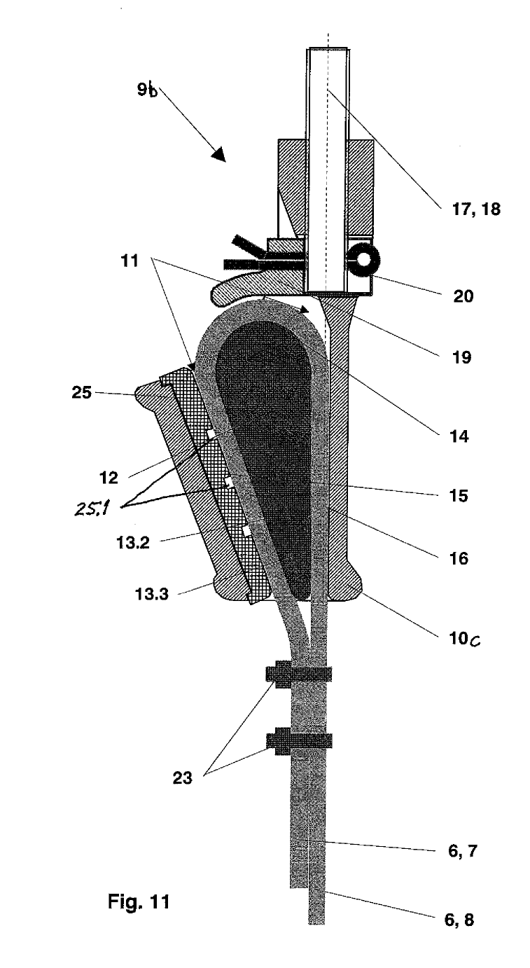

FIG. 11 shows a support means end connection 9b in which the wedge pocket surface 15 is formed by means of an insert part or plate 25. This is advantageous, since the housing 10c can be used for different support means in that merely the insert plates are varied. The surface 15 of the part or plate 25 can have a plurality of transverse flutes or grooves 25.1 formed therein, or the flutes or grooves 25.1 can be formed in the surfaces 15 shown in FIGS. 7 and 10.

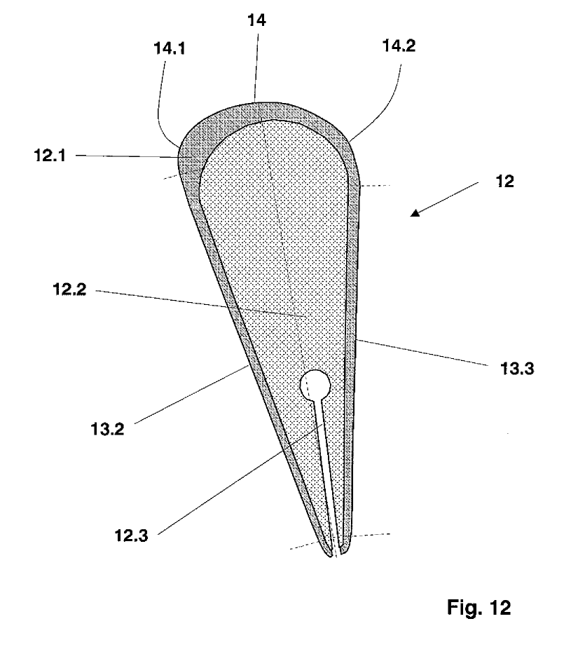

FIG. 12 shows an advantageous construction of the wedge 12. The wedge 12 has a wedge core 12.2 made of, for example, steel. The wedge core 12.2 has an incision 12.3 at its lower end. The incision 12.3 has the effect that the lower end region of the wedge 12 is resilient. The lower region of the wedge surface 13.3 is thus formed to be resilient and a pressing, which is produced by the wedge, reduces in the direction of the lower end of the wedge 12. The wedge core 12.2 has a coating 12.1, which defines the wedge surfaces disposed in contact with the support means 6 (not illustrated). The coating 12.1 is advantageously of a plastics-like material capable of sliding. The coating 12.1 is, for example, formed according to the requirement of the support means contour. The wedge curve 14 is divided up into several radius sections. A first radius section 14.1 adjoins, in the illustrated example, the wedge adhesion surface 13.2. The radius section 14.1 has a small radius which towards the wedge sliding surface 13.3 adjoins an enlarging radius section 14.2.

The illustrated examples are examples of various embodiments of the present invention. The different embodiments can be combined. Thus, the insert part or plate 25 illustrated in FIG. 11 can be combined with wedge constructions according to FIG. 10 or 12, the insert plate can be coated or the insert plate can also be arranged on the side of the supporting run. Obviously, with knowledge of the present invention the shapes and arrangements employed can be changed as desired. Thus, for example, the support means end connection can also be used in a horizontal position of installation.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator installation with a support means end connection and a support means, wherein the support means consists of a cable or cable strands and a cable casing, the cable casing being formed of substantially thermoplastic or elastomeric material and the cable or the cable strand being enclosed by the cable casing, the support means end connection including a wedge housing with a wedge pocket and a wedge, and the support means extending between the wedge and the wedge pocket, looping substantially around the wedge and being held by the wedge in the wedge pocket, comprising:
at least one of a longitudinal wedge groove formed in the wedge, a longitudinal wedge groove formed in the wedge pocket, a region of reduced friction surface on the wedge, a region of reduced friction surface on the wedge pocket and a region of reduced friction surface on the cable casing in the wedge pocket.

2. The elevator installation according to claim 1 wherein the support means has a loose run and a supporting run and said longitudinal wedge groove is formed in one of a wedge adhesion surface and a wedge pocket adhesion surface disposed closer to the loose run of the support means.

3. The elevator installation according to claim 1 wherein the support means has a loose run and a supporting run and at least one of a wedge adhesion surface and a wedge pocket adhesion surface disposed closer to the loose run of the support means has a surface roughness increased relative to a rest of a surface of the wedge pocket.

4. The elevator installation according to claim 1 wherein the support means has a loose run and a supporting run and at least one of a wedge adhesion surface and a wedge pocket adhesion surface disposed closer to the loose run of the support means has formed therein a plurality of transverse flutes or transverse grooves.

5. The elevator installation according to claim 1 wherein the support means has a loose run and a supporting run and at least one of a wedge sliding surface and a wedge pocket sliding surface disposed closer to the supporting run of the support means has formed thereon a reduced coefficient of friction surface.

6. The elevator installation according to claim 1 wherein the support means has a loose run and a supporting run and at least one of a wedge sliding surface and wedge pocket sliding surface disposed closer to the supporting run of the support means has a first surface region and an adjoining second surface region, wherein said first surface region is arranged at an area of exit of the support means from the support means end fastening and said first surface region has a first wedge angle greater than a second wedge angle said second surface region.

7. The elevator installation according to claim 6 wherein said second surface region forms a transition to one of a further surface region of the wedge and an upper end of the wedge pocket surface.

8. The elevator installation according to claim 6 wherein the wedge is formed with resilient end at the area of exit of the support means.

9. The elevator installation according to claim 1 wherein the support means has a loose run and a supporting run and a wedge adhesion surface on the loose run is connected with a wedge sliding surface of the supporting run at an upper end of the wedge by a wedge curve, said curve tangentially adjoining said wedge adhesion and sliding surfaces at both sides, and a radius of curvature of said curve reducing towards said wedge adhesion surface of the loose run.

10. The elevator installation according to claim 1 wherein the wedge is formed of a material which is soft by comparison with steel.

11. The elevator installation according to claim 10 wherein said wedge material is one of aluminium, synthetic material and a compound of metal and synthetic material.

12. The elevator installation according to claim 1 including a removable plate forming a portion of the wedge pocket.

13. The elevator installation according to claim 1 wherein the support means includes at least two cables or cable strands extending at a spacing from one another and a cable casing separating said cables or cable strands from one another, wherein the support means has at least one longitudinal groove formed therein.

14. The elevator installation according to claim 1 wherein an end of the support means is divided into individual cable runs or cable strand runs and each said run is clamped by an associated longitudinal wedge groove formed in one of the wedge and the wedge pocket.

15. The elevator installation according to claim 14 wherein said run is one of glued, fused and mechanically connected with the cable casing in the region of the support means end connection.

16. A method of fastening a support means in an elevator installation comprising the steps of:
a. providing a support means including at least one cable or cable strand and a cable casing, the cable casing being formed of thermoplastic or elastomeric material and enclosing the at least one cable or cable strand;
b. providing a support means end connection having a wedge housing with a wedge pocket and a wedge;
c. forming at least one of a longitudinal wedge groove in a surface of the wedge, a longitudinal wedge groove in a surface of the wedge pocket, a region of reduced coefficient of friction on the wedge, a region of reduced coefficient of friction on the wedge pocket, and a region of reduced coefficient of friction on a portion of the cable casing to be positioned in the wedge pocket; and
d. positioning the support means in the wedge pocket looped around the wedge wherein the wedge holds the support means in the wedge pocket.
